(19) United States
(12) Patent Application Publication
(10) Pub. No.: US 2008/0059096 A1
(43) Pub. Date: Mar. 6, 2008

(54) Electromagnetic Radiation Pulse Timing Control

(75) Inventors: Pontus Stenstrom, Akersberga (SE); Stefan Gullstrand, Danderyd (SE)

Correspondence Address: HAYNES BEFFEL & WOLFELD LLP, P O BOX 366, HALF MOON BAY, CA, 94019, US

(73) Assignee: Micronic Laser Systems AB, Taby (SE)

(21) Appl. No.: 10/542,695

(22) PCT Filed: Jan. 22, 2004
(86) PCT No.: PCT/SE04/00069

§ 371 Date: Oct. 17, 2007

(30) Foreign Application Priority Data
Jan. 22, 2003 (SE) 0300138-5

(51) Int. Cl. G01D 18/00

(52) U.S. Cl. 702/85

(57) ABSTRACT

The present invention relates to a method to reduce the effect of jitter in a pulsed laser system, the method comprising the actions of sending a trigger signal to a power system for producing laser pulses, delaying said trigger signal a first period of time, detecting a period of time between said sending of said triger signal and a corresponding laser pulse, calculating a difference between said detected period of time and a requested period of time, correcting said first period of time in a following laser pulse by said calculated difference. The invention also relates to a pulsed laser system and a laser pattern generator.

### TECHNICAL FIELD

The present invention relates to a compensation method, in particular it relates to a method to reduce the effect of time jitter and drift in pulsed electromagnetic radiation sources.

### BACKGROUND OF THE INVENTION

Modem UV-lithography is searching for new highly parallel writing concepts. Spatial light modulation (SLM) with optical MEMS devices offers such possibilities. An SLM chip may comprise a DRAM-like CMOS circuitry with several million individually addressable pixels on top. Said pixels are deflected due to a difference in electrostatic force between a mirror element and an address electrode. A pattern generator using an SLM is described in U.S. Pat. No. 6,373,619 assigned to the same assignee as this invention. This patent discloses in short a small field stepper, which exposes a series of images of the SLM. A work-piece is arranged on a stage, which is continuously moving and a pulsed electromagnetic radiation source (which could be a pulsed laser, a flash lamp, a flash from a synchrotron light source, etc) flashes and freezes an image of the SLM on the workpiece. The SLM is reprogrammed with a new pattern before each flash so a contiguous image is composed on the workpiece.

Different pulsed electromagnetic sources have different accuracy in a so-called pulse-to-pulse time jitter, i.e., the period of time between adjacent pulses varies. Said time jitter may cause a misplacement of the image field from the spatial light modulator (SLM), which is a problem.

Therefore, what is needed in the art is a method to detect and compensate for the time jitter of a pulsed electromagnetic radiation source and in particular an excimer laser source.

### SUMMARY OF THE INVENTION

Accordingly, it is an object of the present invention to provide a method, which eliminates or at least reduces the above-mentioned problem.

This object, among others, is according to a first aspect of the invention attained by a method to reduce the effect of jitter in a pulsed laser system. A trigger signal is sent to a power system for producing laser pulses. Said trigger signal is delayed a first period of time. A period of time between said sending of said trigger signal and a corresponding laser pulse is detected. A difference between said detected period of time and a requested period of time is calculated. Said first period of time in a following laser pulse is correcting by said calculated difference.

In another embodiment said invention further comprising the actions of: detecting an actual speed of a workpiece onto which said signal will impinge, calculating a difference between said detected speed and a requested speed, correcting said first period of time in a following laser pulse by taking into account said calculated difference in speed.

In another embodiment according to the present invention said laser system is an excimer laser configured to produce radiation at a wavelength of about 248 nm.

In another embodiment according to the present invention said laser system is an excimer laser configured to produce radiation at a wavelength of about 193 nm.

In yet another embodiment according to the present invention said laser system is an excimer laser configured to produce radiation at a wavelength of about 157 nm.

In still another embodiment according to the present invention said laser system is an excimer laser configured to produce radiation at a wavelength of about 126 nm.

In still another embodiment according to the present invention said trigger signal is generated out of information of a position of an object onto which said laser pulses are impinging.

In still another embodiment according to the present invention said trigger signal is generated out of a speed of said object.

The invention also relates to pulsed laser system with jitter control. Said system comprising a laser gas, a pair of electrodes defining a region within which stimulated emission takes place, a power system for generating electrical pulses, a time shift circuit to delay a trigger signal a first period of time, a detector to detect a period of time between said trigger signal and a corresponding laser pulse, and a connecting device to correct said first period of time in a following laser pulse by an amount of time corresponding to a difference between said detected period of time and a requested period of time.

In another embodiment said laser system further comprising a detector to detect a speed of a workpiece onto which said pulsed laser will impinge, and a correcting device to correct said first period of time in a following laser pulse by taking into account a difference between said detected speed and a requested speed of the workpiece.

The invention also relates to a method to compensate jitter in a laser pattern generator using a pulsed laser system to illuminate a spatial light modulator, which modulator relays illumination to expose a workpiece on a moving stage. Said compensation comprising the actions of sending a trigger signal to a power system for producing laser pulses, delaying said trigger signal a first period of time, detecting a period of time between said sending of said trigger signal and a corresponding laser pulse, calculating a difference between said detected period of time and a requested period of time, and compensating said first period of time in a following laser pulse by said calculated difference.

In another embodiment said laser pattern generator further comprising the action of detecting a speed of said workpiece, calculating a difference between said detected speed and a requested speed of said workpiece, and compensating said first period of time in a following laser pulse by taking into account said difference in speed.

The invention also relates to a method to reduce jitter in a pulsed laser system, comprising the actions of sending a trigger signal to a power system for producing laser pulses, delaying said trigger signal a first period of time, detecting a period of time between said sending of said trigger signal and a corresponding laser pulse, calculating a difference between said detected period of time and a requested period of time, repeating the action of calculating differences between detected time periods and requested time periods until fluctuations in jitter can be approximated by a mathematical expression, and predicting said first period of time in a following laser pulse out of said mathematical expression.

The invention also relates to a laser pattern generator comprising a jitter compensation module, a spatial light modulator illuminated by a pulsed laser system, which modulator relays illumination to expose a workpiece on a moving stage. Said jitter compensation module comprising a detector to detect a period of time between sending a trigger signal for producing laser pulses and a corresponding laser pulse, a time shift device for delaying said trigger signal a certain amount of time, a device for calculating a difference between said detected period of time and a requested period of time, and a compensator, which compensates said difference in a following laser pulse by adjusting said delay of said trigger signal.

In another embodiment said pattern generator further comprising a detector to detect a speed of said workpiece, a device for calculating the difference of said detected speed and a requested speed of the workpiece, and a compensator which takes into account said difference in speed when adjusting the delay of said trigger signal.

The invention also relates to a pulsed laser system with jitter control, said system comprising a laser gas, a pair of electrodes defining a region within which stimulate emission takes place, a power system for generating electrical pulses, a time shift circuit to delay a trigger signal a first period of time, a detector to detect a period of time between said trigger signal and a corresponding signal, and a calculator for calculating an approximate formula of fluctuations in jitter out of calculated differences between a plurality of detected time periods and requested time periods, wherein said first period of time is predicted for a following laser pulse out of said approximate formula.

The invention also relates to a method to reduce the effect of jitter in a pulsed laser system, comprising the actions of sending a trigger signal to a system for producing laser pulses, detecting a corresponding laser pulse, correcting a trigger position in a following laser pulse corresponding to any deviation of said detected laser pulse from a requested position of time for said laser pulse.

In another embodiment said method further comprising the actions of detecting the actual speed of a workpiece onto which said signal will impinge, calculating a difference between said detected speed and a requested speed, and correcting the trigger position in the following laser pulse by taking into account said difference in speed.

The invention also relates to a laser pattern generator comprising a jitter compensation module, a spatial light modulator illuminated by a pulsed laser system, which modulator relays illumination to expose a workpiece on a moving stage. Said jitter compensation module comprising a detector to detect laser pulses, a trigger generator for generating trigger signals, and a compensator to compensate a trigger signal position in a following laser pulse corresponding to any deviation of a detected laser pulse from a requested position of time for said laser pulse.

In another embodiment said laser pattern generator further comprising: a detector to detect a speed of said workpiece, a device for calculating the difference of said detected speed and a requested speed of the workpiece, a compensator which takes into account said difference in speed when adjusting said trigger signal position.

The invention also relates to a pulsed laser system with jitter control, said system comprising a laser gas, a pair of electrodes defining a region within which stimulated emission takes place, a trigger generator, a detector to detect laser pulses, and a correcting device to correct a trigger position in a following laser pulse corresponding to any deviation of a detected laser pulse from a requested position of time for said laser pulse.

In another embodiment said pulsed laser system further comprising a detector to detect a speed of said workpiece, a device for calculating the difference of said detected speed and a requested speed of the workpiece, and a compensator which takes into account said difference in speed when adjusting said trigger signal position.

Further characteristics of the invention, and advantages thereof, will be evident from the detailed description of preferred embodiments of the present invention given hereinafter and the accompanying FIGS. 1-6, which are given by way of illustration only, and thus are not limitative of the present invention.

### BRIEF DESCRIPTION OF THE DRAWINGS

FIG. 1 depicts a schematic overview of a prior art pattern generator using a spatial light modulator.

FIG. 2 depicts a schematic illustration of a first embodiment of an inventive method for reducing jitter according to the present invention.

FIG. 3 depicts a schematic illustration of a second embodiment of an inventive method for reducing jitter according to the present invention.

FIG. 4 depicts schematically a side view of a prior art excimer laser.

FIG. 5 depicts a schematic illustration of a third embodiment of an inventive method for reducing jitter according to the present invention.

FIG. 6 depicts schematically the relation between a laser trigger position and requested laser pulse.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

Further, the preferred embodiments are described with reference to an analogue SLM. It will be obvious to one with ordinary skill in the art that there may be situations when other SLMs than analogue ones will be equally applicable; for example digital SLMs like a digital micromirror device (DMD) made by Texas instruments. Additionally, SLMs may be comprised of reflective or transmissive pixels. Even further, the preferred embodiments are described with reference to an excimer lacer source. It will be obvious to one with ordinary skill in the art that a pulsed electromagnetic radiation source other than an excimer laser may be equally compensated by the inventive method, for instance a Nd-YAG laser, ion laser, Ti sapphire laser, free electron laser or other pulsed fundamental frequency lasers, flash lamps, laser plasma sources, synchrotron light sources etc.

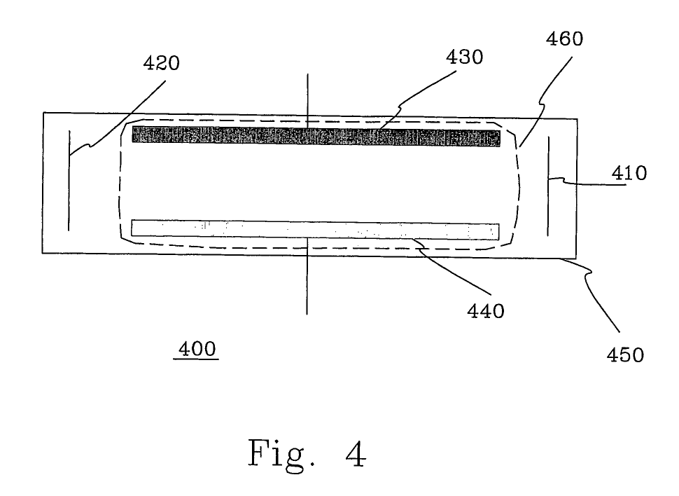

FIG. 4 shows a prior art transversally excited laser 100, for example an excimer laser. Said laser 100 comprises a first mirror 410 and a second mirror 420 together forming a resonant cavity 470. The laser 100 further comprising a first electrode 430 and a second electrode 440 together forming a discharge volume 460. A housing 450 encloses said discharge volume 460 and said resonant cavity. One of the mirrors 410 or 420 is partially reflecting for allowing a beam of radiation created within the resonant cavity to be emitted. The other minor is totally reflecting. The housing is transparent for emitted wavelength in an end where said partially reflecting mirror is arranged. Within the discharge volume there is a laser gas. By applying an appropriate high voltage over said first and second electrodes, said laser gas will start to emit electromagnetic radiation due to stimulated emission. The wavelength of said electromagnetic radiation depends of the laser gas used.

The invention relates to a method to compensate for time jitter in a pulsed electromagnetic radiation source. Such a method is inter alia useful when patterning a workpiece using a spatial light modulator (SLM), where a pulsed electromagnetic radiation is impinged onto said SLM and relays images of said spatial light modulator, which images are stitched together at a continuously moving stage.

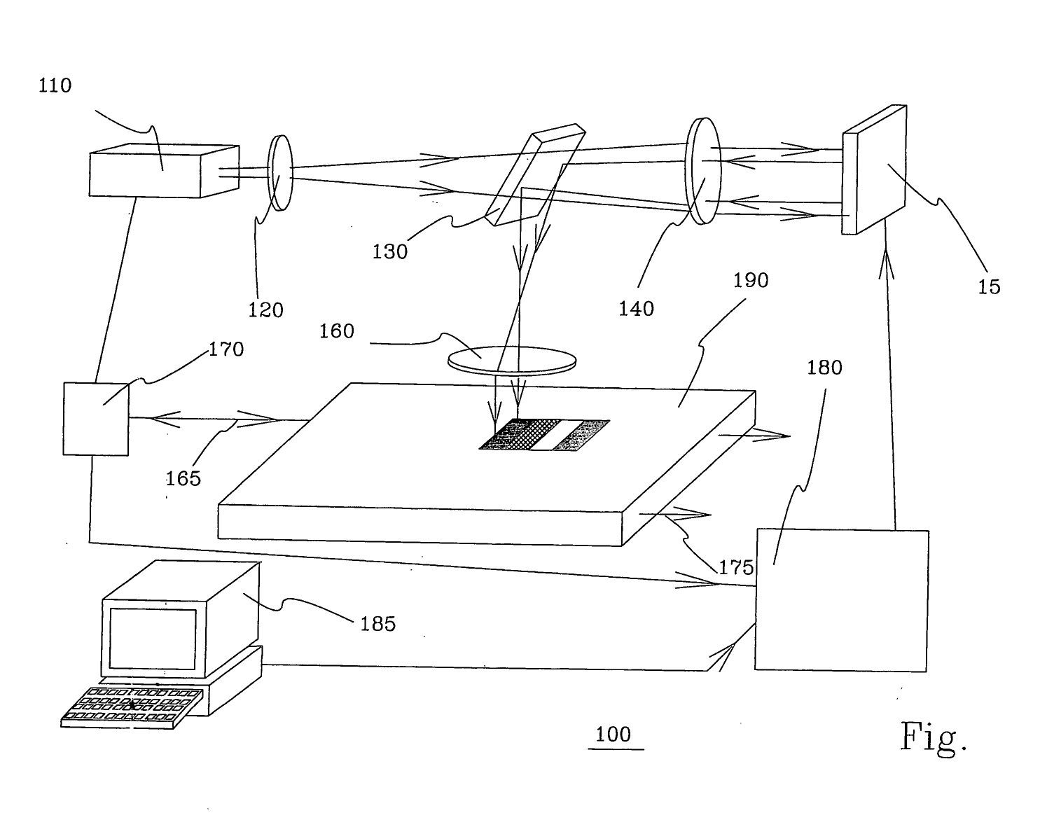

FIG. 1 illustrates schematically a pattern generator using a spatial light modulator according to prior art technology. Said pattern generator comprises an electromagnetic radiation source 110, a first lens 120, a semitransparent mirror 130, a second lens 140, a spatial light modulator 150, a third lens 160, an interferometer 170, a pattern bitmap generator 180, a computer 185, a workpiece 190.

The laser source 110 may be an excimer laser emitting for instance 308 nm, 248 nm 193 nm, 156 nm, or 126 nm pulses. Said pulses are homogenized and shaped by the homogenizing and shaping lenses 120, 140. Said lenses 120, 140 comprise optics such that plane waves are exposing the Surface of the SLM 150. The temporal pulse length of the laser may be 0.1 μs or smaller, for instance 10 ns. The pulse repetition rate of the laser may be 0.5-5 kHz, for instance 2 kHz.

The third lens 160 determines the demagnification of the system. When using an analogue spatial light modulator, a spatial filter and a Fourier lens (not illustrated in the figure) are arranged between the third lens 160 and the semitransparent mirror 130.

The computer 185 generates the pattern to be imaged onto the workpiece. Said workpiece may be a transparent substrate covered with a layer with chrome which in turn is covered with a layer of photosensitive material. This is an example of a workpiece used in the manufacturing of masks and reticles. The workpiece may also be a semi-conducting wafer onto which the pattern is directly generated without a mask. This pattern may be generated by conventional software used in the lithography industry. Said pattern is transformed into a bitmap representation by the pattern bitmap generator 180. Said bitmap representation is in its turn transformed into drive signals for the spatial light modulator by said bitmap generator 180. Said drive signals will set individual pixel elements in said spatial light modulator 150 into a desired modulation state. In case of an analogue spatial light modulator a specific drive signal will correspond to a specific deflection state of a particular pixel element. Deflection states of an analogue pixel element such as a micro mirror operated in an analogue mode may be set to any number of states between fully deflected and non-deflected, for instance 64, 128 or 256 states.

The interferometer 170 continuously detects the position of the workpiece. The workpiece may move with a constant speed when patterning a strip of stamps. The workpiece may also move with a variable speed. When the workpiece moves with a variable speed, it is necessary to detect the actual speed a short time period before illuminating the SLM in order to be sure that a stamp of the SLM will be printed at a requested position on the workpiece. The stamp is a reproduction of the pattern of the SLM onto the workpiece. A reduction of the pattern of the SLM may be performed through one or a plurality of lenses before being reproduced onto the workpiece. Several stamps stitched together will form a strip. Strips stitched together will form a complete image. The interferometer 170 transmits and receives signals 165 for detecting said position of the workpiece. When the workpiece is at a given position detected by said interferometer a trigger signal is sent to the laser. One way of generating said trigger signal is to compare a detected value of position of the workpiece with a stored value of position. When there is a match between a stored value of position, in for example a look up table, and a detected value of position a trigger signal will be generated. Said trigger signal will eventually cause the laser to pulse.

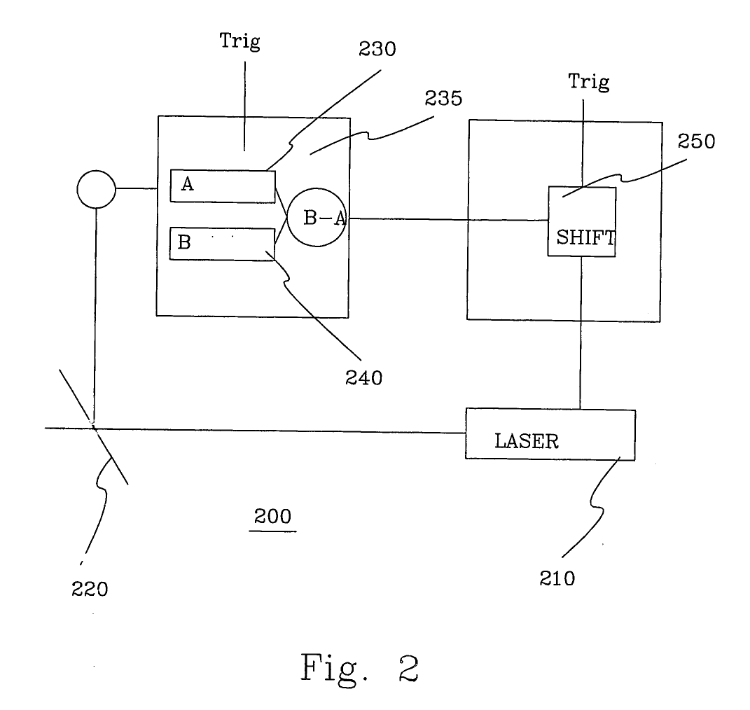

In FIG. 2 is illustrated a schematic representation of a first embodiment of an apparatus 200 according to the present invention for reducing jitter. Said apparatus comprises a laser 210, a semitransparent mirror 220, a flash measure device 235 and a time shift device 250 for the trigger signal. The trigger signal, for starting a laser pulse from the laser, is transmitted into a time shift device 250. Said time shift device holds said signal a certain time before transmitting said trigger signal to the laser 210.

At a pulse rate of 1 kHz and a demagnified SLM size in the direction of movement of the workpiece of 50 μm, the writing speed will be 50 mm/s. At 1 kHz pulse rate and with a temporal pulse length of each pulse of 10 ns, there is a time space of 0.99 μs between each pulse. In one embodiment the interferometer is calibrated to generate a trigger signal in the middle of said time space, i.e., 0.495 μs after the end of the laser pulse. With no time jitter the time shift device holds said trigger signal for another 0.495 μs before sending said trigger signal to the laser. However, other holding times for said trigger signal is also possible, which holding time may be greater or smaller than said 0.495 μs. For instance, in one embodiment the trigger signal is held a time period being equal to the 100 ns. In another embodiment said trigger signal is held a time period of 25 ns.

The light delay from said trigger signal depends on several factors, inter alia the charging voltage in a laser chamber and the actual temperature of the laser chamber. Without knowing the charging voltage and said temperature this invention compensates for errors in pulse timing, i.e., jitter, by using the knowledge of a delay of at least one earlier laser pulse.

The trigger signal is detected by a detector 230 and starts a clock in the flash measure device 235. The same trigger signal is transmitted to said time shift device 250. When the laser pulse is detected by said detector 230 said clock is stopped. A time-period between the trigger signal and the laser pulse, denoted A, is compared with a requested value, which is denoted with B. A difference between said requested value B and said actual time period A is calculated. Said difference can be used to compensate the jitter in the next pulse by delaying said trigger signal more or less, where increasing the delay correspond to a positive difference and decreasing the delay corresponds to a negative difference. The information about said difference is sent to the time shift device 250 which will increase or decrease the delay by said difference.

In another embodiment of the present invention, which may be used when starting up the laser, one call detect a plurality, i.e., two, three, four or more pulses to see variations in said pulse timing. By doing so it is possible to detect a trend or an oscillation of the error of pulse timing around a certain value. Said variation or oscillation can be used to predict the next error in pulse timing. After a certain number of pulses one can fit a curve represented by a given formula to said variations of error in pulse timing or jitter. Said curve can be used when predicting the timing of the following laser pulse. A curve fit may be performed using numerical approximation or other statistical methods for making a prediction of a next coming pulse.

Before using the laser for pattern generation, i.e., during start up procedure a number of pulses is ran through a test loop to determine the characteristics of the particular laser at a particular event, when this has been determined said laser may be used our pattern formation, i.e., flashes will be allowed to impinge on the SLM 150 to expose the workpiece 190.

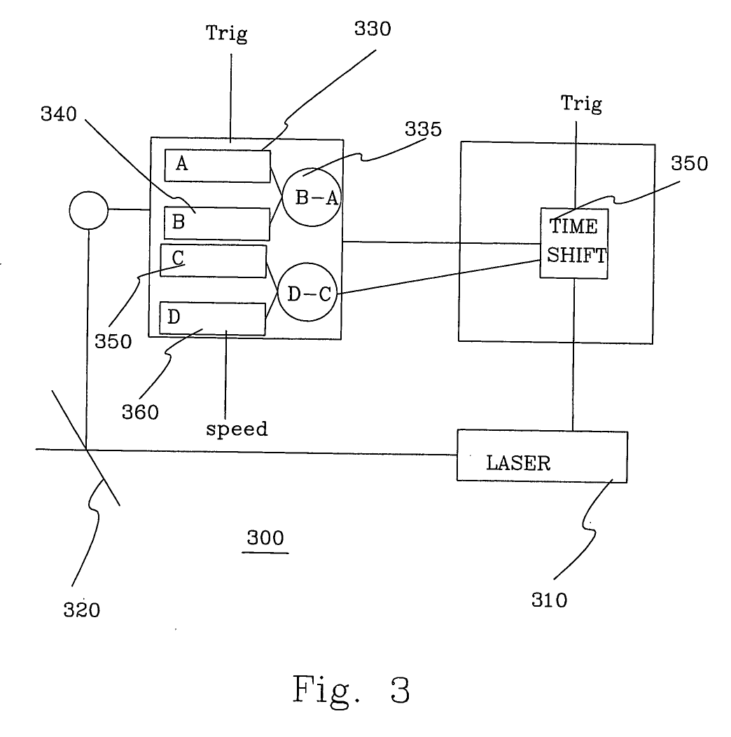

FIG. 3 depicts yet another embodiment according to the present invention. The embodiment comprises a laser 310, a semitransparent mirror 320, a flash measure device 335 and a time shift device 350 for the trigger signal. The trigger signal, for starting a laser pulse from the laser, is transmitted into the time shift device 350. Said time shift device holds said signal a certain period of time before transmitting said trigger signal to the laser 310.

The trigger signal is detected by a detector 330 and starts a clock in the flash measure device 235. The same trigger signal is transmitted to said time shift device 350. When the laser pulse is detected by said detector 330 said clock is stopped. A time-period between the trigger signal and the laser pulse, denoted A, is compared with a requested value, which is denoted with B. A difference between said requested value B and said actual time period A is calculated. Said difference can be used to compensate the jitter in the next pulse by delaying said trigger signal more or less, where increasing the delay correspond to a positive difference and decreasing the delay corresponds to a negative difference. The information about said difference is sent to the time shift device 250 which will increase or decrease the delay by said difference.

This embodiment further comprises a speed detector 360 which detects a speed of a workpiece onto which said pulsed laser will impinge. The speed of the workpiece is regulated by an analogue or digital servo. The actual speed of tile workpiece, denoted C, is measured in the time interval between laser pulses. The time shift device may compensate a difference between the actual speed C of the workpiece from a requested speed of the same, denoted D, by an increase or decrease of the delay of the trigger signal. A too slow movement of the workpiece, i.e., the difference between requested speed D and actual speed C is a positive value, will result in an increase of a delay time of the trigger signal and a too rapid movement of the workpiece, i.e., the difference between requested speed D and actual speed C is a negative value, will result in a decrease of a delay time of said trigger signal.

The speed of the workpiece may be measured at any moment between laser pulses. In one embodiment the speed of the workpiece is measured just before sending the trigger signal to the laser. By doing so, compensation of speed variations of the workpiece by altering the delay time of the trigger signal will use as fresh detected speed as possible and thereby possibly enhancing the accuracy.

In yet another embodiment a combination of adjusting the speed of the workpiece and a variation of the delay of the trigger signal is performed for said jitter reduction.

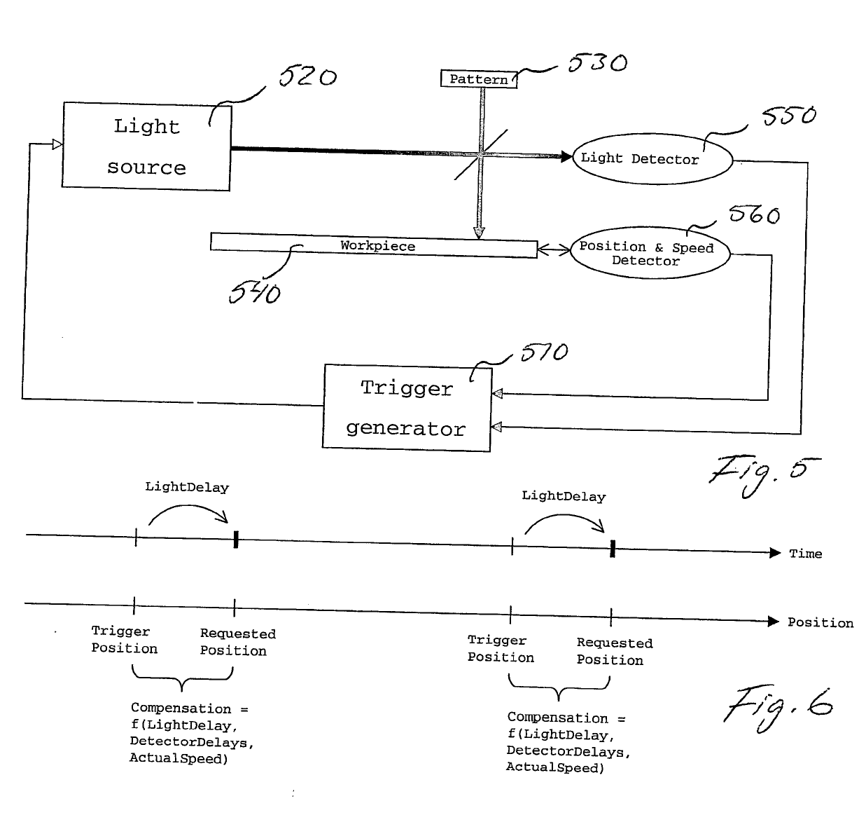

FIG. 5 illustrates another embodiment for compensating the effect of jitter in a pulsed electromagnetic radiation system according to the present invention. This embodiment comprises a trigger generator 510, a light source 520, a modulator 530, a workpiece 540, a light detector 550 and a position and speed detector 560. The trigger generator 510 receives information about the speed and position of the workpiece 540, indicated in FIG. 5 as being a mask substrate. Said trigger generator also receives information about when light is detected by said light detector 550. Trigger pulses are generated according to a predetermined position pattern of said workpiece, which is for instance stored in a look up table. A trigger pulse is generated when there is a match between said stored value and said detected position. Variations in speed are corrected for by moving the trigger position forward or backward. In FIG. 6 there is a schematic illustration of two laser pulses from for example an excimer laser. FIG. 6 depicts the light delay between a trigger position of the workpiece and a requested position of impinging light onto the workpiece. The delay has to be compensated for. The compensation is a function of (light delay, detector delays, actual speed of the workpiece, temperature and pressure).

When the trigger pulse is sent to the light source 520 it will take a certain time until the light pulse is generated. The light delay may vary from one pulse to another. The resulting time jitter or drift translates into jitter and drifts of the stamp positions onto the workpiece, which may result in printed pattern line widths going out of predetermined specifications. In this embodiment the requested position from the look up table is corrected to obtain a new position against which the stage position is compared. The correction is obtained from the last measured delay (or statistics from several earlier measurements) optionally together with a speed measurement, where said measured delay and said optionally speed measurement is subtracted from the requested position. In this manner, speed variations over the strip are also corrected for. This embodiment differs to the ones in FIG. 2 and 3 in that there is no delay circuit. Variations in light delay are cancelled by correcting the trigger position instead of correcting the light delay by adding a variable time delay.

As in the previously described embodiments one can use information about jitter from only one earlier pulse to reduce jitter in a following pulse or information about jitter from a plurality of pulses to reduce jitter in a following pulse by altering the delay in the time shifter or correcting the trigger position. When using information from more than one earlier pulse a better prediction about the jitter in a following pulse may be performed due to the fact that the jitter may follow a characteristic variation pattern. By knowing the jitter variations one can make a better prediction about jitter in a next coming pulse.

In a pattern generator, a test loop may be performed between each strip of stamps. Said test loop generates statistical material at said location in order to flash the pattern of the SLM onto a requested position of the workpiece as accurate as possible.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

1. A method to reduce the effect of jitter in a pulsed laser system, comprising the actions of:
sending a trigger signal to a power system for producing laser pulses,
delaying said trigger signal a first period of time,
detecting a period of time between said sending of said trigger signal and a corresponding laser pulse,
calculating a difference between said detected period of time and a requested period of time,
correcting said first period of time in a following laser pulse by said calculated difference.

2. The method according to claim 1 further comprising the actions of:
detecting an actual speed of a workpiece onto which said signal will impinge,
calculating a difference between said detected speed and a requested speed,
correcting said first period of time in a following laser pulse by taking into account said calculated difference in speed.

3. The method according to claim 1, wherein said laser system is an excimer laser configured to produce radiation at a wavelength of about 248 nm.

4. The method according to claim 1, wherein said laser system is an excimer laser configured to produce radiation at a wavelength of about 193 nm.

5. The method according to claim 1, wherein said laser system is an excimer laser configured to produce radiation at a wavelength of about 157 nm

6. The method according to claim 1, wherein said laser system is an excimer laser configured to produce radiation at a wavelength of about 126 nm.

7. The method according to claim 1, wherein said trigger signal is generated out of information of a position of an object onto which said laser pulses are impinging.

8. The method according to claim 7, wherein said trigger signal is generated out of a speed of said object.

9. A pulsed laser system with jitter control, said system comprising:
a laser gas
a pair of electrodes defining a region within which stimulated emission takes place,
a power system for generating electrical pulses,
a time shift circuit to delay a trigger signal a first period of time,
a detector to detect a period of time between said trigger signal and a corresponding laser pulse,
a correcting device to correct said first period of time in a following laser pulse by an amount of time corresponding to a difference between said detected period of time and a requested period of time.

10. The pulsed laser system according to claim 9 further comprising:
a detector to detect a speed of a vorkpiece onto which said pulsed laser will impinge,
a correcting device to correct said first period of time in a following laser pulse by talking into account a difference between said detected speed and a requested speed of the workpiece.

11. A method to compensate jitter in a laser pattern generator using a pulsed laser system to illuminate a spatial light modulator, which modulator relays illumination to expose a workpiece on a moving stage, wherein said compensation comprising the actions of:
sending a trigger signal to a power system for producing laser pulses,
delaying said trigger signal a first period of time,
detecting a period of time between said sending of said trigger signal and a corresponding laser pulse,
calculating a difference between said detected period of time and a requested period of time,
compensating said first period of time in a following laser pulse by said calculated difference.

12. The method according to claim 11 further comprising the action of:
detecting a speed of said workpiece,
calculating a difference between said detected speed and a requested speed of said workpiece,
compensating said first period of time in a following laser pulse by taking into account said difference in speed.

13. A method to reduce jitter in a pulsed laser system, comprising the actions of:
sending a trigger signal to a power system for producing laser pulses,
delaying said trigger signal a first period of time,
detecting a period of time between said sending of said trigger signal and a corresponding laser pulse,
calculating a difference between said detected period of time and a requested period of time,
repeating the action of calculating differences between detected time periods and requested time periods until fluctuations in jitter can be approximated by a mathematical expression,
predicting said first period of time in a following laser pulse out of said mathematical expression.

14. A laser pattern generator comprising a jitter compensation module, a spatial light modulator illuminated by a pulsed laser system, which modulator relays illumination to expose a workpiece on a moving stage, said jitter compensation module comprising:
a detector to detect a period of time between sending a trigger signal for producing laser pulses and a corresponding laser pulse,
a time shift device for delaying said trigger signal a certain amount of time,
a device for calculating a difference between said detected period of time and a requested period of time,
a compensator, which compensates said difference in a following laser pulse by adjusting said delay of said trigger signal.

15. The laser pattern generator according to claim 14 further comprising:
a detector to detect a speed of said workpiece,
a device for calculating the difference of said detected speed and a requested speed of the workpiece,
a compensator which takes into account said difference in speed when adjusting the delay of said trigger signal.

16. A pulsed laser system with jitter control, said system comprising:
a laser gas,
a pair of electrodes defining a region within which stimulate emission takes place,
a power system for generating electrical pulses,
a time shift circuit to delay a trigger signal a first period of time,
a detector to detect a period of time between said trigger signal and a corresponding signal,
a calculator for calculating an approximate formula of fluctuations in jitter out of calculated differences between a plurality of detected time periods and requested time periods, wherein said first period of time is predicted for a following laser pulse out of said approximate formula.

17. A method to reduce the effect of jitter in a pulsed laser system, comprising the actions of:
sending a trigger signal to a system for producing laser pulses,
detecting a corresponding laser pulse,
correcting a trigger position in a following laser pulse corresponding to any deviation of said detected laser pulse from a requested position of time for said laser pulse.

18. The method according to claim 17, further comprising the actions of:
detecting the actual speed of a workpiece onto which said signal will impinge,
calculating a difference between said detected speed and a requested speed,
correcting the trigger position in the following laser pulse by talking into account said difference in speed.

19. A laser pattern generator comprising a jitter compensation module, a spatial light modulator illuminated by a pulsed laser system, which modulator relays illumination to expose a workpiece on a moving stage, said jitter compensation module comprising:
a detector to detect laser pulses,
a trigger generator for generating trigger signals,
a compensator to compensate a trigger signal position in a following laser pulse corresponding to any deviation of a detected laser pulse from a requested position of time for said laser pulse.

20. The laser pattern generator according to claim 19 further comprising:
a detector to detect a speed of said workpiece,
a device for calculating the difference of said detected speed and a requested speed of the workpiece,
a compensator which takes into account said difference in speed when adjusting said trigger signal position.

21. A pulsed laser system with jitter control, said system comprising:
a laser gas
a pair of electrodes defining a region within which stimulated emission takes place,
a trigger generator,
a detector to detect laser pulses,
a connecting device to correct a trigger position in a following laser pulse corresponding to any deviation of a detected laser pulse from a requested position of time for said laser pulse.

22. The pulsed laser system according to claim 21 further comprising:
a detector to detect a speed of said workpiece,
a device for calculating the difference of said detected speed and a requested speed of the workpiece,
a compensator which takes into account said difference in speed when adjusting said trigger signal position.
